(19) United States
(12) Patent Application Publication
(10) Pub. No.: US 2007/0127996 A1
(43) Pub. Date: Jun. 7, 2007

(54) Method and apparatus for milling a component of a turbo-engine

(75) Inventors: Stefan Heinrich, Adelshofen (DE); Arndt Glaesser, Dachau (DE); Goetz Lebkuechner, Germering (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 11/544,965

(22) Filed: Oct. 6, 2006

(30) Foreign Application Priority Data
Oct. 8, 2005 (EP) 05 021 985.6

(51) Int. Cl. B23C 3/00

(52) U.S. Cl. 409/132; 29/557; 29/889.23

(57) ABSTRACT

A milling method and apparatus for the fabrication of components from materials that are difficult to cut for turbo-engines, producing recesses having one or more side walls, in particular for the fabrication of integrally bladed rotors for gas turbines, in which the recesses form flow channels and the side walls form blade surfaces of an integrally bladed rotor, are disclosed. A milling cutter rotates centrally about an axis of a milling machine. The milling cutter additionally executes an eccentric circular motion about a circular path axis at a distance from the axis of the milling machine. The axis of the circular path including the milling cutter executes an advance motion on a straight and/or curved path. The milling cutter includes cutting edges that are contoured with projections and recesses.

This application claims the priority of European Patent Application No. 05 021 985.6, filed Oct. 8, 2005, the disclosure of which is expressly incorporated by reference herein.

### BACKGROUND AND SUMMARY OF THE INVENTION

The invention relates to a method and apparatus for milling.

German Patent Document No. DE 102 19 012 B4 discloses a milling method for the fabrication of components from difficult-to-machine materials for turbo-engines. The milling method disclosed there is used in particular for the fabrication of integrally bladed rotors for gas turbines, where recesses to be milled form flow channels, and the side walls bordering the recesses form blade surfaces of the integrally bladed gas turbine rotor. In the milling method according to DE 102 19 012 B4, a milling cutter is driven to rotate about the milling axis such that the milling cutter executes an eccentric rotary motion about a circular path axis at a distance from the axis of the milling machine in addition to this central rotation about the axis of the milling machine. The direction of rotation here is opposite the direction of rotation of the circular motion, and the rotational speed of this rotation is significantly higher than the rotational speed of the rotary motion. In addition, the rotary path axis including the milling cutter executes an advance motion on a straight and/or curved path with or without a pivoting motion. Milling with such a motion of the milling cutter is also referred to as trochoidal milling.

Referring to trochoidal milling, the milling cutter which is disclosed in DE 102 19 012 B4 and has smooth cutting edges is used. Due to the geometry of this milling cutter and its motion, a very large chip volume is generated per unit of time with a relatively large chip geometry in trochoidal milling, which is why the removal of chips from the chip channel of the milling cutter poses problems. In addition, the milling cutters have a tendency to vibrate heavily, which can cause damage to some.

Against this background, the problem on which the present invention is based is to create a novel milling method and apparatus. According to this invention, a milling cutter whose cutting edges are contoured with projections and recesses is used.

Within the meaning of the present invention, a milling cutter whose cutting edges are contoured with projections and recesses is used for trochoidal milling. Such contouring of the cutting edges of the milling cutter is also referred to as knurled gearing. Use of such a milling cutter has the advantage that the chips produced in milling have a much smaller chip geometry and therefore can be removed from the chip channel with no problem. In addition, with the help of such milling cutters, it is possible to eliminate vibrations in trochoidal milling, so that wear on the milling cutters is minimized. This makes it possible to implement a longer service life and/or tool life of the milling cutters.

Preferred developments of the invention are derived from the following description.

### BRIEF DESCRIPTION OF THE DRAWINGS

Exemplary embodiments of the invention are explained in greater detail below with reference to the drawings, without being limited to these embodiments.

FIG. 1 illustrates a milling cutter in accordance with the principles of the present invention; and

FIG. 2 is a detail II of the milling cutter from FIG. 1.

### DETAILED DESCRIPTION OF THE DRAWINGS

The invention relates to a milling method and apparatus for fabrication of components from difficult-to-machine materials for turbo-engines, producing recesses having one or more side walls. The inventive milling method and apparatus is used in particular for fabrication of integrally bladed rotors for gas turbines in which the recesses form flow channels and the side walls form blade surfaces of the integrally bladed rotor to be manufactured.

The inventive milling method is a trochoidal milling method; details of trochoidal milling are known from DE 102 19 012 B4, and U.S. Patent Application Publication 2003/0202854 A1 which is a family member of DE 102 19 012, the disclosures of which are hereby incorporated by reference herein. For the sake of thoroughness, it should be pointed out here that in trochoidal milling, a milling cutter rotates centrally around an axis of the milling cutter, whereby the milling cutter additionally executes an eccentric circular motion about a circular path axis at a distance from the axis of the milling machine. The direction of rotation about the axis of the milling machine is identical to the direction of rotation of the circular motion (co-rotational), whereby the rotational speed in rotation about the axis of the milling machine is significantly higher than the rotational speed in the circular motion. The axis of the circular path, including the milling cutter moving in an eccentric path around this axis, executes a translational advance motion on a straight and/or curved path, with or without a pivoting motion across its longitudinal direction. As already mentioned, additional details can be learned from DE 102 19 012 B4.

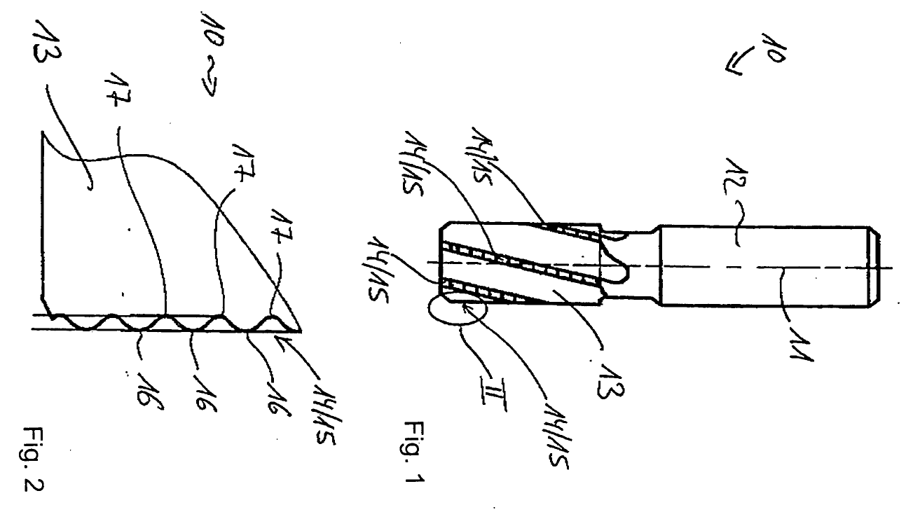

Within the meaning of the present invention, a milling cutter whose cutting edges are contoured with projections and recesses is used for milling. Such a milling cutter is illustrated in FIGS. 1 and 2.

FIG. 1 shows a milling cutter 10 which is used in the inventive milling method and executes the aforementioned central rotation about an axis 11 of the milling machine in milling mode. The milling cutter 10 has two sections 12 and 13, with the section 12 of the milling cutter 10 serving to chuck same in a milling machine. Cutting blades 14 having cutting edges 15 are designed in section 13 of the milling cutter 10.

As shown in FIG. 2 in particular, the cutting edges 15 of the cutting blades 14 are contoured with projections 16 and recesses 17. Such contouring of the cutting edges 15 is also known as knurled gearing.

In the diagram shown in FIG. 2, the projections 16 and the recesses 17 form a wave-like contour which is formed by designing both the projections 16 and the recesses 17 so that they are rounded. It should be pointed out that the projections and recesses may also be designed with sharp edges and then form a trapeze-like or triangle-like contouring of the cutting edges.

The projections 16 and the recesses 17 may lie either on helical lines or on circular lines.

When using the milling cutter illustrated in FIGS. 1 and 2 for trochoidal milling, vibrations of the milling cutter can be eliminated, so that the milling cutter is subject to less stress and less wear. In addition, chips having a relatively small chip geometry are formed in trochoidal milling by using the milling cutter illustrated in FIGS. 1 and 2, and such chips can be removed from a chip channel with no problem.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A milling method for the fabrication of components from difficult-to-machine materials for turbo-engines, producing recesses having one or more side walls, in particular for the fabrication of integrally bladed rotors for gas turbines in which the recesses form flow channels and the side walls form blade surfaces of an integrally bladed rotor, wherein a milling cutter rotates centrally about an axis of a milling machine, wherein the milling cutter additionally executes an eccentric circular motion about a circular path axis at a distance from the axis of the milling machine, and wherein the circular path axis including the milling cutter executes an advanced motion on a straight and/or curved path, and wherein the milling cutter includes cutting edges that are contoured with projections and recesses.

2. The milling method according to claim 1, wherein the cutting edges of the milling cutter used for milling are contoured as a knurled gearing.

3. The milling method according to claim 1, wherein the projections and the recesses on the cutting edges of the milling cutter used for milling each lie on at least one helical line.

4. The milling method according to claim 1, wherein the projections and the recesses on the cutting edges of the milling cutter used for milling lie on multiple circular lines.

5. The milling method according to claim 1, wherein the projections and the recesses form a wave-like or trapeze-like or triangle-like contour.

6. A method for milling a component of a turbo-engine, comprising the steps of:
moving a milling cutter, including:
rotating the milling cutter centrally about an axis of a milling machine;
moving the milling cutter in an eccentric circular motion about a circular path axis at a distance from the axis of the milling machine; and
translationally advancing the milling cutter on a straight and/or curved path; and
producing a recess having a side wall in the component by the step of moving the milling cutter;
wherein the milling cutter includes a cutting edge that is contoured with a projection and a recess.

7. The milling method according to claim 6, wherein the component is an integrally bladed rotor of a gas turbine engine.

8. The milling method according to claim 6, wherein the projection and the recess have a triangular shape.

9. The milling method according to claim 6, wherein the projection and the recess have a rounded shape.

10. The milling method according to claim 6, wherein the projection and the recess lie on a helical path on a cutting section of the milling cutter.

11. The milling method according to claim 6, wherein the projection and the recess lie on a circular path on a cutting section of the milling cutter.

12. The milling method according to claim 7, wherein the recess defines a flow channel in the integrally bladed rotor.

13. The milling method according to claim 7, wherein the side wall defines a blade surface of the integrally bladed rotor.

14. An apparatus for milling a component of a turbo-engine, comprising:
a milling cutter, wherein the milling cutter is:
rotatable centrally about an axis of a milling machine;
movable in an eccentric circular motion about a circular path axis at a distance from the axis of the milling machine; and
translationally moveable on a straight and/or curved path;
and wherein the milling cutter includes a cutting edge that is contoured with a projection and a recess.

15. The apparatus according to claim 14, wherein the projection and the recess have a triangular shape.

16. The apparatus according to claim 14, wherein the projection and the recess have a rounded shape.

17. The apparatus according to claim 14, wherein the projection and the recess lie on a helical path on a cutting section of the milling cutter.

18. The apparatus according to claim 14, wherein the projection and the recess lie on a circular path on a cutting section of the milling cutter.
